(19) United States
(12) Patent Application Publication
(10) Pub. No.: US 2016/0258358 A1
(43) Pub. Date: Sep. 8, 2016

(54) HIGH TURNING ANGLE EJECTOR COOLED TURBINE ENGINE EXHAUST DUCT

(71) Applicant: Sikorsky Aircraft Corporation, Stratford, CT (US)

(72) Inventors: Michael Kazlauskas, Watertown, CT (US); Daniel Bernier, Royal Palm Beach, FL (US)

(21) Appl. No.: 14/969,951

(22) Filed: Dec. 15, 2015

Related U.S. Application Data
(60) Provisional application No. 62/126,790, filed on Mar. 2, 2015.

(51) Int. Cl. F02C 7/141; F01D 9/02; B64C 27/00; F01D 25/30; F02C 7/18; B64D 33/04; F01D 5/02; F01D 9/06

(52) U.S. Cl. CPC F02C 7/141; F01D 5/02; F01D 9/02; F01D 9/06; F01D 25/305; F02C 7/18; B64D 33/04; B64C 27/00; F05D 2220/30; F05D 2240/24; F05D 2240/128; F05D 2260/20

(57) ABSTRACT

An exhaust duct for a turbine engine is provided including a duct having a generally hollow interior configured to receive a primary flow from a turbine section of the turbine engine and an ejector cooling air flow from an ejector of the turbine engine. The duct has a first end arranged in a first plane and a second end arranged in a second, distinct plane. The first plane and the second plane are arranged at an angle to one another between 70 degrees and 110 degrees.

### CROSS-REFERENCE TO RELATED APPLICATIONS

This patent application claims priority to U.S. Provisional Patent Application Ser. No. 62/126,790, filed Mar. 2, 2015, which is incorporated herein by reference in its entirety.

### STATEMENT REGARDING FEDERALLY SPONSORED RESEARCH OR DEVELOPMENT

This invention was made with government support with the United States Navy under Contract No. N00019-06-C-0081. The government therefore has certain rights in this invention.

### BACKGROUND OF THE INVENTION

Exemplary embodiments of the invention relate to a rotary wing aircraft, and more particularly, to an exhaust duct of a turbine engine of a rotary wing aircraft.

Rotary-wing aircraft commonly use one or more turbine engines having an ejector arrangement to provide cooling airflow to the engine compartment at all airspeeds. An annular gap formed between an exhaust duct and the rear of the engine exists which allows air from the compartment to flow through and out the exhaust duct. In such systems, the high speed flow provided by the engine exhaust is the primary flow, and the air passing through the compartment and the ejector gap is the secondary air flow. In this arrangement, the exhaust duct acts as the ejector mixing duct, with the combined engine exhaust and compartment cooling ultimately exiting the exhaust duct. The ejector system provides a means of pumping cooling air through the compartment without needing an active system, such as an electrically driven fan.

The efficiency of such ejector systems is highly dependent on the geometry of the ejector gap and downstream exhaust duct, especially if the exhaust duct includes high loss features or a large turning angle. The maximum turning angle of the exhaust duct is normally limited by the need for satisfactory ejector performance and associated compartment cooling. However, a high turning angle may be desired in order to minimize external exhaust effects on the aircraft, such as impingement of hot exhaust gasses on the skin of the aircraft, reingestion of exhaust into the engine inlet, or due to other packaging constraints based on aircraft geometry. Sub-optimal design of the exhaust duct can result in a limited secondary cooling air flow, or in extreme cases, exhaust backflow, in which hot engine exhaust flows back into the compartment, where engine component allowable temperatures may be exceeded, or other types of thermal or fire damage may occur.

### BRIEF DESCRIPTION OF THE INVENTION

According to one embodiment of the invention, an exhaust duct for a turbine engine is provided including a duct having a generally hollow interior configured to receive a primary flow from a turbine section of the turbine engine and an ejector cooling air flow from an ejector of the turbine engine. The duct has a first end arranged in a first plane and a second end arranged in a second, distinct plane. The first plane and the second plane are arranged at an angle to one another between 70 degrees and 110 degrees.

In addition to one or more of the features described above, or as an alternative, in further embodiments a turning vane is arranged generally centrally within the hollow interior of the duct. The turning vane has a contour generally complementary to the duct.

In addition to one or more of the features described above, or as an alternative, in further embodiments an offset vane is arranged near an outboard side of the exhaust duct. The offset vane is configured to limit backflow of the primary flow.

In addition to one or more of the features described above, or as an alternative, in further embodiments the offset vane is oriented substantially parallel to and spaced away from the outboard side of the exhaust duct.

In addition to one or more of the features described above, or as an alternative, in further embodiments a flow blocker extends from an aft end of the offset vane towards the adjacent surface of the exhaust duct.

In addition to one or more of the features described above, or as an alternative, in further embodiments a diameter of the duct is generally constant extending from the first end to the second end.

In addition to one or more of the features described above, or as an alternative, in further embodiments the duct has a generally asymmetric profile such that a radius extending from a centerline of the duct in a first direction is greater than a radius extending in a second, substantially opposite direction over at least a portion of a length between the first end and the second end.

According to another embodiment of the invention, a turbine engine is provided including a primary nozzle arranged downstream from a turbine section. An exhaust duct is arranged in an overlapping configuration with the primary nozzle such that an ejector opening is defined between an exterior of the primary nozzle and an interior of the exhaust duct. The exhaust duct is configured to receive a primary flow from the turbine section and an ejector cooling air flow via the ejector opening. The duct has a first end arranged in a first plane and a second end arranged in a second, distinct plane. The first plane and the second plane are arranged at an angle to one another between 70 degrees and 110 degrees.

In addition to one or more of the features described above, or as an alternative, in further embodiments a turning vane is arranged generally centrally within the hollow interior of the duct. The turning vane has a contour generally complementary to the duct.

In addition to one or more of the features described above, or as an alternative, in further embodiments an offset vane is arranged near an outboard side of the exhaust duct, the offset vane being configured to limit backflow of the primary flow.

In addition to one or more of the features described above, or as an alternative, in further embodiments the offset vane is oriented substantially parallel to and spaced away from the outboard side of the exhaust duct.

In addition to one or more of the features described above, or as an alternative, in further embodiments a flow blocker extends from an aft end of the offset vane towards the adjacent surface of the exhaust duct.

In addition to one or more of the features described above, or as an alternative, in further embodiments a diameter of the duct is generally constant extending from the first end to the second end.

In addition to one or more of the features described above, or as an alternative, in further embodiments the duct has a generally asymmetric profile such that a radius extending from a centerline of the duct in a first direction is greater than a radius extending in a second, substantially opposite direction over at least a portion of a length between the first end and the second end.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an example of a rotary wing aircraft;

FIG. 2 is a cross-sectional view of an example of a gas turbine engine of a rotary wing aircraft;

FIG. 3 is a cross-sectional view of an example or another gas turbine engine of a rotary wing aircraft;

FIG. 4 is a perspective view of an exhaust duct of a gas turbine engine according to an embodiment of the invention;

FIG. 5 is a side view of an exhaust duct of a gas turbine engine according to an embodiment of the invention; and

FIG. 6 is a schematic diagram of a plurality of turbine engines and the exhaust ducts associated therewith of a rotary-wing aircraft according to an embodiment of the invention.

The detailed description explains embodiments of the invention, together with advantages and features, by way of example with reference to the drawings.

### DETAILED DESCRIPTION OF THE INVENTION

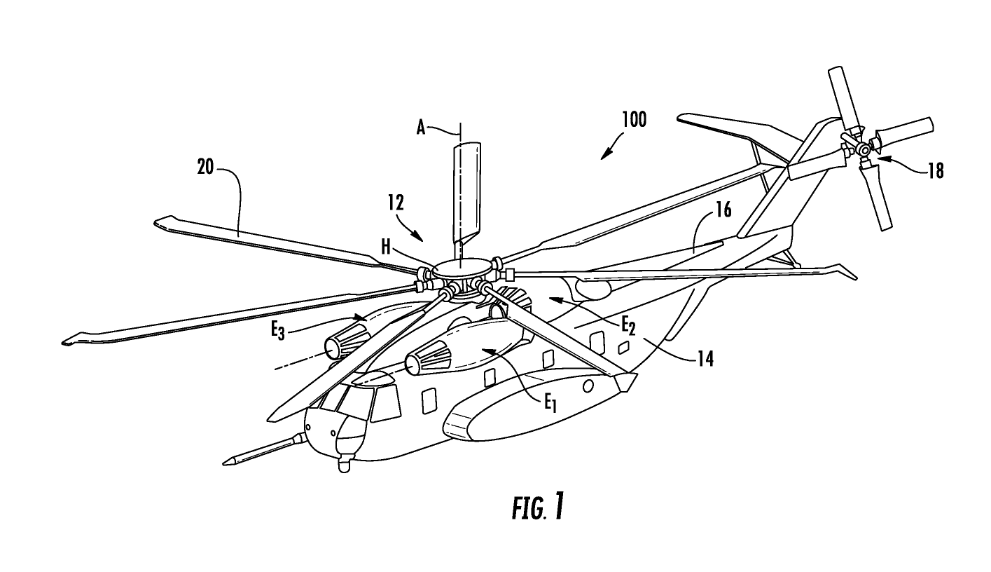

FIG. 1 schematically illustrates a rotary wing aircraft 10 having a main rotor assembly 12. The aircraft 10 includes an airframe 14 having an extended tail 16 which mounts a tail rotor system 18, such as an anti-torque system, a translational thrust system, a pusher propeller, a rotor propulsion system, and the like. The main rotor assembly 12 includes a plurality of rotor blade assemblies 20 mounted to a rotor hub H. The main rotor assembly 12 is driven about an axis of rotation A through a main gearbox (illustrated schematically at T) by one or more engines E. Although a particular helicopter configuration is illustrated and described in the disclosed embodiment, other configurations and/or machines, such as high speed compound rotary wing aircrafts with supplemental translational thrust systems, dual contra-rotating, coaxial rotor system aircrafts, tilt-rotors and tilt-wing aircrafts, and fixed wing aircrafts, will also benefit from embodiments of the invention.

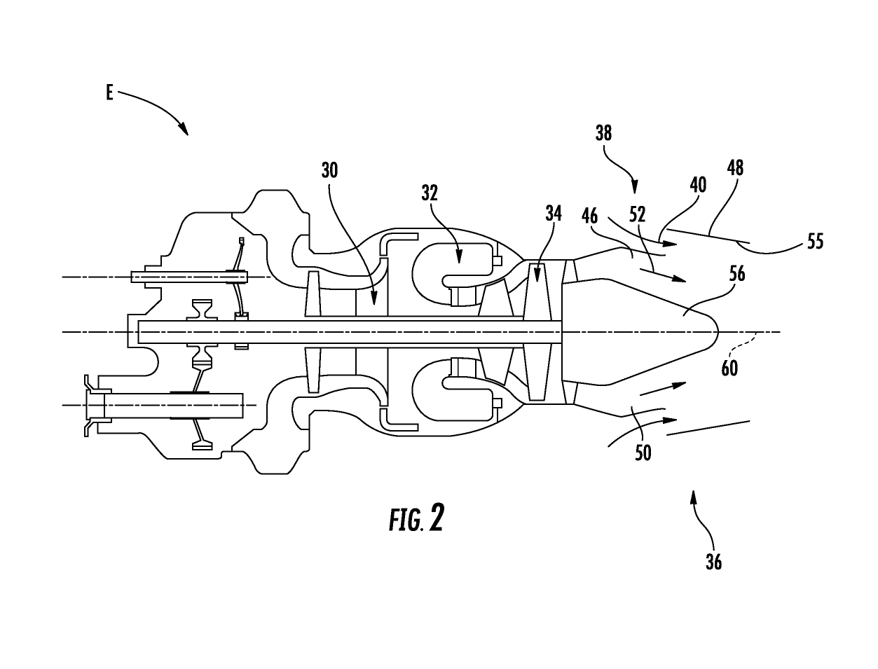

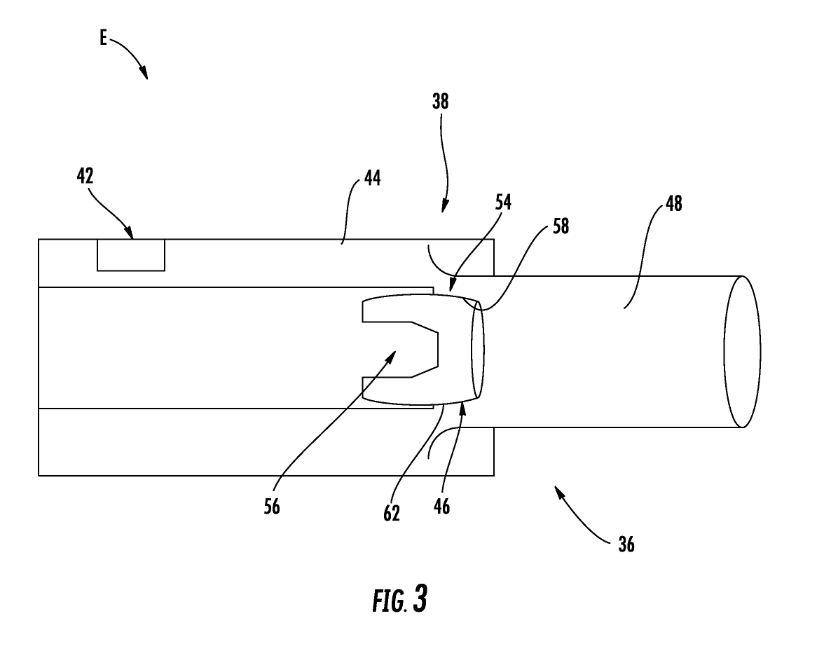

Referring now to FIGS. 2 and 3, an example of a cross-section of one of the plurality of engines E of a rotary wing aircraft is illustrated in more detail. The illustrated engine E is a gas turbine engine comprising, in serial flow communication, a multi-stage compressor 30 for pressurizing the air, a combustor 32 in which the compressed air is mixed with fuel and ignited for generating an annular stream of hot combustion gases, and a turbine section 34 for extracting energy from the combustion gases. The turbine engine E terminates in an exhaust section 36.

As shown, the exhaust section 36 includes an exhaust ejector 38 which is used to draw an external air flow 40 for ventilation or cooling through an inlet 42 formed in the engine housing 44 (FIG. 3). In the illustrated, non-limiting embodiment, the exhaust ejector 38 includes a primary nozzle 46 and an adjacent exhaust duct or shroud 48. The primary nozzle 46 has a generally tubular wall 50 configured to guide a flow of exhaust gasses exiting from the turbine section 34. The exhaust gasses travelling through and subsequently exiting the nozzle 46, referred to as the primary flow 52, move in a direction generally indicated by the arrow. At the same time, the external air flow 40 travels through the opening 54 (FIG. 3) formed between the primary nozzle 46 and an interior 56 of the exhaust duct 48 such that the external air flow 40 and the primary flow 52 mix within the exhaust duct 48.

In embodiments where a center body 56 is arranged within the nozzle 46, as shown in FIG. 2, the primary flow 52 is generally annular. However, the configuration of the flow path of the primary flow 52 through the nozzle 46 is affected by the shape of the inner surface 58 (FIG. 3) of the tubular wall 50. A central axis 60 can be defined relative to the tubular wall 50. Accordingly, the tubular wall 50 can be said to have a radially-inner surface 58 exposed to the primary flow 50 and an opposite radially-outer surface 62 (FIG. 3), a portion of which may be exposed to a radially-outer surrounding medium, such as the external air flow 40 for example.

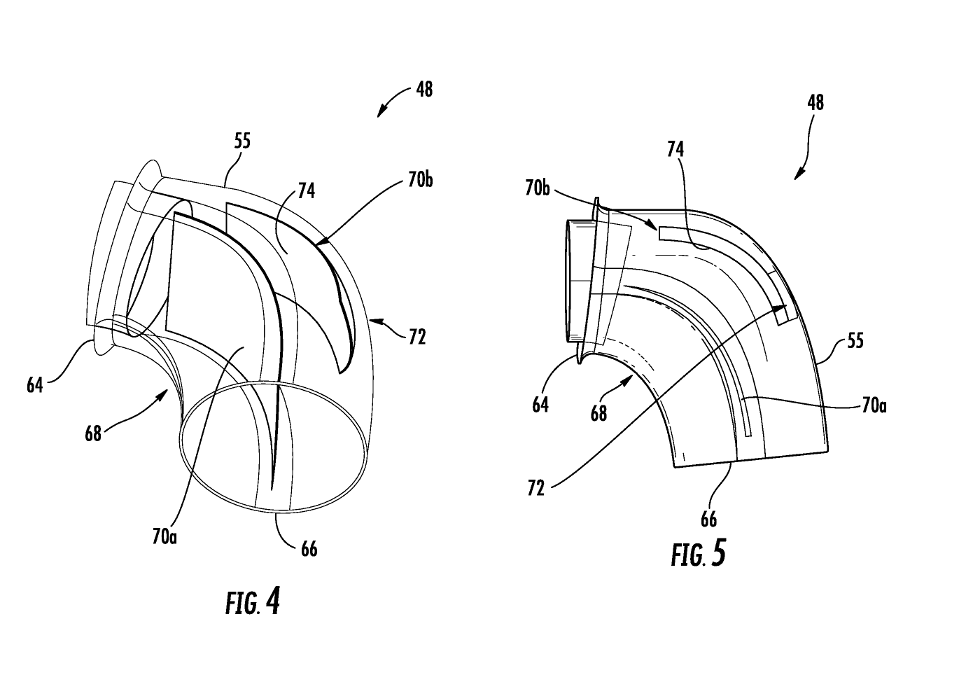

Referring now to FIGS. 4-6, the exhaust duct 48 of the gas turbine engine E is illustrated in more detail. As shown, the end 64 of the exhaust duct 48 adjacent the primary nozzle 46 is arranged within a first plane and a second, opposite end 66 of the exhaust duct 48 is arranged within a second plane. As a result, the second plane is arranged at an angle to the first plane and the duct 48 therefore includes a bend region 68. In one embodiment, the exhaust duct has a high turning angle between about 70° and 110° such that the first end 64 and the second end 66 thereof are oriented generally perpendicular to one another. In the illustrated, non-limiting embodiment, the exhaust duct 48 has a generally asymmetrical profile. In such instances, a radius of the duct 48 extending from a centerline (not shown) thereof in a first direction is greater than a radius of the duct 48 extending in a second, substantially opposite direction over at least a portion of the length of the duct 48, such as adjacent between the first end 64 and the bend region 68 formed therein for example. However, exhaust ducts 48 having other profiles, such as a duct 48 having a generally constant diameter over its length for example, is within the scope of the invention.

As best shown in FIGS. 4 and 5, at least one vane 72 is mounted within the hollow interior of the exhaust duct 48 to minimize the occurrence of backflow, such as of the primary flow 52, through the ejector gap 54 formed between the primary nozzle 46 and the exhaust duct 48. In one embodiment, a turning vane 70a is mounted to and has a contour generally complementary to the center of the duct 48. The turning vane 70a may extend over only a portion of the length of the exhaust duct 48, or alternatively, may extend generally from the first end 64 to the second end 66 thereof Alternatively, or in addition, an offset vane 70b may be arranged adjacent an outboard side of the exhaust duct 48. As shown, the offset vane 70b is generally shorter in length than the duct 48 and has a contour similar to the adjacent surface of the duct 48 such that the offset vane 70b is substantially parallel thereto.

While travelling from the nozzle 46 into the exhaust duct, the primary flow 52 contacts and impinges on a surface 74 of the offset vane 70b rather than on the wall 55 of the exhaust duct itself. This contact of the primary flow 52 creates a space into which the external air flow 40 from the ejector gap 54 can flow without directly contacting the primary exhaust flow 52. As a result of the impingement of the primary exhaust flow 52, a high pressure region is formed at the outboard portion of the bend region or turn of the exhaust duct 48. In one embodiment, a flow blocker 72 is coupled to or integrally formed with the offset vane 70b adjacent a downstream end. The flow blocker 72 extends substantially perpendicularly from a surface of the offset vane 70b towards the outboard side of the duct 48. The flow blocker 72 is configured to prevent the high pressure external air flow 40 and primary flow 52 from flowing back towards the ejector gap 54 and causing poor performance or backflow.

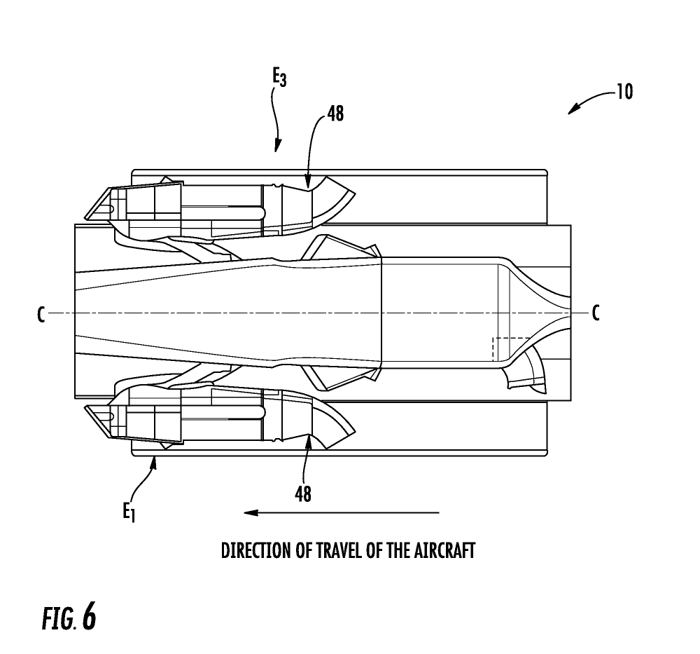

Referring now to FIG. 6, a schematic diagram of the configuration of a plurality of gas turbine engines of a rotary-wing aircraft is illustrated. Two engines E1 and E3 are arranged adjacent opposing sides of the airframe 14 and engine E2 is mounted adjacent the tail 16, such as in a position offset to the left side of the main rotor pylon. As shown, engines E1 and E3 are substantially identical and arranged symmetrically about a centerline C of the aircraft 10. Engine E2 includes an exhaust duct 48 having a high turn angle between 70° and 110°. In one embodiment, the exhaust duct 48 is oriented such that the second, outlet end 66 of the exhaust duct 48 is configured to expel the exhaust gas vertically upward, away from the tail 16. Embodiments where another one of the plurality of engines E, such as E1 or E3 for example, or where all of the plurality of engines E have an exhaust duct 48 with a high turn angle are within the scope of the invention.

Exhaust duct 48 allows an ejector cooling system to be utilized on an aircraft regardless of the degree of the turning angle without limiting the amount of ejector cooling air. In addition, the duct 48 minimizes the risk of backflow while improving the performance of a gas turbine engine.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An exhaust duct for a turbine engine comprising:
a duct having a generally hollow interior configured to receive a primary flow from a turbine section of the turbine engine and an ejector cooling air flow from an ejector of the turbine engine, the duct having a first end arranged in a first plane and a second end arranged in a second, distinct plane, the first plane and the second plane being arranged at an angle to one another, the angle being between 70 degrees and 110 degrees.

2. The exhaust duct of claim 1, wherein a turning vane is arranged generally centrally within the hollow interior of the duct, the turning vane having a contour generally complementary to the duct.

3. The exhaust duct of claim 1 or claim 2, wherein an offset vane is arranged near an outboard side of the exhaust duct, the offset vane being configured to limit backflow of the primary flow.

4. The exhaust duct according to claim 3, wherein the offset vane is oriented substantially parallel to and spaced away from the outboard side of the exhaust duct.

5. The exhaust duct according to either claim 3 or claim 4, wherein a flow blocker extends from an aft end of the offset vane towards the adjacent surface of the exhaust duct.

6. The exhaust duct according to any of the preceding claims wherein a diameter of the duct is generally constant extending from the first end to the second end.

7. The exhaust duct according to any of claim 1-5, wherein the duct has a generally asymmetric profile such that a radius extending from a centerline of the duct in a first direction is greater than a radius extending in a second, substantially opposite direction over at least a portion of a length between the first end and the second end.

8. A turbine engine comprising:
a primary nozzle arranged downstream from a turbine section;
an exhaust duct arranged in an overlapping configuration with the primary nozzle such that an ejector opening is defined between an exterior of the primary nozzle and an interior of the exhaust duct, the exhaust duct being configured to receive a primary flow from the turbine section and an ejector cooling air flow via the ejector opening, the duct having a first end arranged in a first plane and a second end arranged in a second, distinct plane, the first plane and the second plane being arranged at an angle to one another, the angle being between 70 degrees and 110 degrees.

9. The turbine engine of claim 8, wherein a turning vane is arranged generally centrally within the hollow interior of the duct, the turning vane having a contour generally complementary to the duct.

10. The turbine engine of claim 8 or claim 9, wherein an offset vane is arranged near an outboard side of the exhaust duct, the offset vane being configured to limit backflow of the primary flow.

11. The turbine engine according to claim 10, wherein the offset vane is oriented substantially parallel to and spaced away from the outboard side of the exhaust duct.

12. The turbine engine according to either claim 10 or claim 11, wherein a flow blocker extends from an aft end of the offset vane towards the adjacent surface of the exhaust duct.

13. The turbine engine according to any of the preceding claims wherein a diameter of the duct is generally constant extending from the first end to the second end.

14. The turbine engine according to any of claim 8-12, wherein the duct has a generally asymmetric profile such that a radius extending from a centerline of the duct in a first direction is greater than a radius extending in a second, substantially opposite direction over at least a portion of a length between the first end and the second end.
